(19) United States
(12) Patent Application Publication
(10) Pub. No.: US 2011/0077817 A1
(43) Pub. Date: Mar. 31, 2011

(54) Vehicle Diagnostic System And Method Thereof

(76) Inventors: Chin-Yang Sun, Taipei (TW); Chih-Hong Sun, Taipei (TW)

(21) Appl. No.: 12/568,677

(22) Filed: Sep. 29, 2009

(51) Int. Cl. G01M 17/00

(52) U.S. Cl. 701/34; 701/29

(57) ABSTRACT

A vehicle diagnostic system and a method are provided. The vehicle diagnostic system includes a receiving/processing module, and a database. The receiving/processing module is adapted for receiving the information related to a status of vehicle components from an OBD-II interface connected thereto. The information is then analyzed by a processing logic, so as to generate a vehicle health diagnostic report with respect to the corresponding vehicle components. In the vehicle health diagnostic report including the one or more table, in addition to enumerating the operation status of the vehicle components as “Pass/Fail”, there is also shown a testing result of the vehicle components, and there are also provided additional information and suggestions related to the vehicle components. The processing logic is stored in receiving/processing module and/or in the database.

### BACKGROUND OF THE INVENTION

1. Field of the Invention

The present invention relates generally to a vehicle diagnostic system and a method thereof, and more particularly, to a vehicle diagnostic system and a method thereof which are adapted for enumerating a testing result of various vehicle components being diagnosed, and providing related information and suggestions in a vehicle health diagnostic report, in addition to showing a status of the vehicle components as either “Pass” or “Fail”.

2. The Prior Arts

Currently, because of the booming of the environmentalism, as well as the continuously increasing number of vehicles running on the earth, more strict regulations have been announced in many countries for restricting the exhaust gas emission of vehicles.

In the earlier days, for the purpose reducing the exhaust gas emission of vehicles, emission control components, such as air flow meter, catalytic converter, oxygen sensor are required to be equipped to engines of the vehicles. Hence, the on-board diagnostic (OBD) system is correspondingly proposed for monitoring whether the emission control components are in normal working conditions.

A first generation OBD system, which are generally referred as “OBD-I”, was compulsorily required to be equipped to all new vehicles sold in California starting in manufacturer's year 1988. The issuance of the OBD-I was to remind the owner or the driver of the vehicle whenever a pollution-related component malfunction occurs, by which the malfunction can be fixed, and the corresponding pollution can be minimized. The further, the OBD-I can also facilitate to monitor electric malfunction of main sub-systems or components, such as engine. When the malfunction is fixed, a malfunction indicator lamp (MIL) indicating the malfunction is then automatically turned dark.

The OBD-I system can monitor the operation of the engine, and when a malfunction of any emission control element occurs, the OBD-I alarms and ignites the MIL on the instrument panel, so as to alert the driver to clear the malfunction and the recovery the emission control element to normal operation. Typically, when a malfunction is detected by the OBD-I system, the data and information of the malfunction is stored in a memory by an electronic control unit (ECU), and an OBD scan tool is employed to read the diagnostic trouble code (DTC) from the memory, according to which the component of the malfunction and the characteristics of the malfunction can be determined.

The items which can be monitored by the OBD-I system mainly include the fuel injection system, oxygen sensor, exhaust gas recirculation (EGR) system, and main input sensors, and output actuators.

Subsequent to the OBD-I system, in 1994, OBD-II system is proposed. The OBD-II system is adapted for monitoring the aging condition or malfunction of pollution-related sub-systems or components. The OBD-II system has standardized the vehicle health diagnostic specification, in which the emission value is restricted to be less than 1.5 times of that of a new vehicle, and the MIL is turned dark after a recovery operation while there is no similar malfunction occurs during three circulations. The OBD-II system further introduced some monitoring items including catalyst converter (CAT), misfire test without checking engine light, evaporative system (EVAP) leak, EGR, and secondary air injection system.

Currently, a conventional vehicle diagnostic system can obtain information related to the components of the vehicle by accessing the OBD-II system loaded on the vehicle, so as to summaries a vehicle health diagnostic report enumerating items related to the components of the vehicle. However, in such a vehicle health diagnostic report, the enumerated items can be showed as “Pass/Fail” only, and therefore, the vehicle health diagnostic report cannot provide a further testing result of the components, and cannot further provide additional information and suggestions related to the vehicle components.

As such, it is very much desired to propose a vehicle health diagnostic system, adapted for diagnosing the health condition of a vehicle. The vehicle health diagnostic system is desired to be adapted for accessing information related to a status of vehicle components from an OBD-II interface connected thereto. The information for example includes diagnostic trouble codes (DTC), designated data, additional information, and parameters related to the status of the vehicle components. In such a way, an optimal vehicle health diagnostic report can be obtained. In such an optimal vehicle health diagnostic report, there are enumerated additional information and suggestions related to the vehicle components in addition to the items related to the components of the vehicle showed as “Pass/Fail”.

### SUMMARY OF THE INVENTION

A primary objective of the present invention is to provide a vehicle diagnostic system and a method thereof, adapted for diagnosing the health condition of a vehicle. The vehicle health diagnostic system and the method are adapted for obtaining a vehicle health diagnostic report, in which there are enumerated additional information and suggestions related to the vehicle components in addition to the items related to the components of the vehicle showed as “Pass/Fail”.

A further objective of the present invention is to provide a vehicle diagnostic system and a method thereof, adapted for diagnosing the health condition of a vehicle. The vehicle health diagnostic system and the method are adapted for accessing diagnostic trouble codes (DTC), designated data, additional information, and parameters related to the status of the vehicle components from an OBD-II interface, and correspondingly generating a vehicle health diagnostic report related to the vehicle components by processing the accessed diagnostic trouble codes (DTC), designated data, additional information, and parameters with a processing logic.

For achieving the foregoing objectives and others, the present invention provides a vehicle diagnostic system including a receiving/processing module, and a database.

The receiving/processing module is adapted for receiving the information related to a status of vehicle components from an OBD-II interface connected thereto. The information for example includes diagnostic trouble codes (DTC), designated data, additional information, and parameters related to the status of the vehicle components. The information is then analyzed by a processing logic, so as to generate a vehicle health diagnostic report with respect to the corresponding vehicle components. Specifically, the vehicle health diagnostic report includes one or more table stored in the database. In the vehicle health diagnostic report including the one or more table, in addition to enumerating the operation status of the vehicle components as “Pass/Fail”, there is also shown a testing result of the vehicle components, and there are also provided additional information and suggestions related to the vehicle components. The processing logic is stored in receiving/processing module and/or in the database.

The database is adapted for storing a vehicle health diagnostic report including one or more table, and/or a processing logic. The receiving/processing module accesses the database for retrieving the processing logic for preparing the vehicle health diagnostic report related to the vehicle components. Further, according to an aspect of the invention, the receiving/processing module accesses the database for retrieving the vehicle health diagnostic report including the one or more table stored in the database, and providing the vehicle health diagnostic report to other systems for printing the vehicle health diagnostic report into a paperwork or displaying the vehicle health diagnostic report on a display screen, so as to allow the user to be aware of the additional information and suggestions related to the vehicle components.

In the operation of utilizing the vehicle health diagnostic system according to the present invention to diagnose a vehicle, at first, the receiving/processing module receives the information accessing information related to a status of vehicle components from an OBD-II interface connected thereto. The information for example includes diagnostic trouble codes (DTC), designated data, additional information, and parameters related to the status of the vehicle components. Then, the receiving/processing module analyzes the received information with the processing logic, thus obtaining a vehicle health diagnostic report with respect to the corresponding vehicle components. Specifically, the vehicle health diagnostic report includes one or more table, and the one or more table can be stored in a database. The receiving/processing module accesses the database to retrieve the vehicle health diagnostic report including the one or more table, and outputs the retrieved vehicle health diagnostic report to other systems. Finally, the vehicle health diagnostic report is printed into paperwork or displayed on a display screen, so as to allow the user to be aware of the additional information and suggestions related to the vehicle components.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a structure of a vehicle diagnostic system and the operation thereof according to an embodiment of the present invention;

FIG. 2 is a flow chart illustrating steps of a vehicle diagnostic method executed with the vehicle diagnostic system of FIG. 1 according to an embodiment of the present invention;

FIG. 3 is a flow chart illustrating steps of a vehicle diagnostic method executed with the vehicle diagnostic system of FIG. 1 according to a further embodiment of the present invention;

FIG. 4 is a flow chart illustrating a detailed procedure of the step of receiving the information related to a status of the vehicle components of FIGS. 2 and 3;

FIG. 5 is a flow chart illustrating a detailed procedure of the step of generating a vehicle health diagnostic report of FIGS. 2 and 3;

FIG. 6 is a flow chart illustrating the procedure of executing the vehicle diagnostic method of FIG. 3 according to an embodiment of the present invention;

FIG. 7a is a summary table showing a testing result of a plurality of sensors;

FIG. 7b is a summary table showing a testing result of the vehicle component test;

FIG. 7c is a summary table showing a testing result of the DTC test;

FIG. 7d is a summary table showing a testing result of the emission test;

FIG. 8a is a table showing a testing result of a plurality of sensors of the OBD-II system;

FIG. 8b is a table showing a result of a component test of the OBD-II system;

FIG. 8c is a table showing a result of a DTC test of the OBD-II system; and

FIG. 8d is a table showing a result of an emission test of the OBD-II system.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

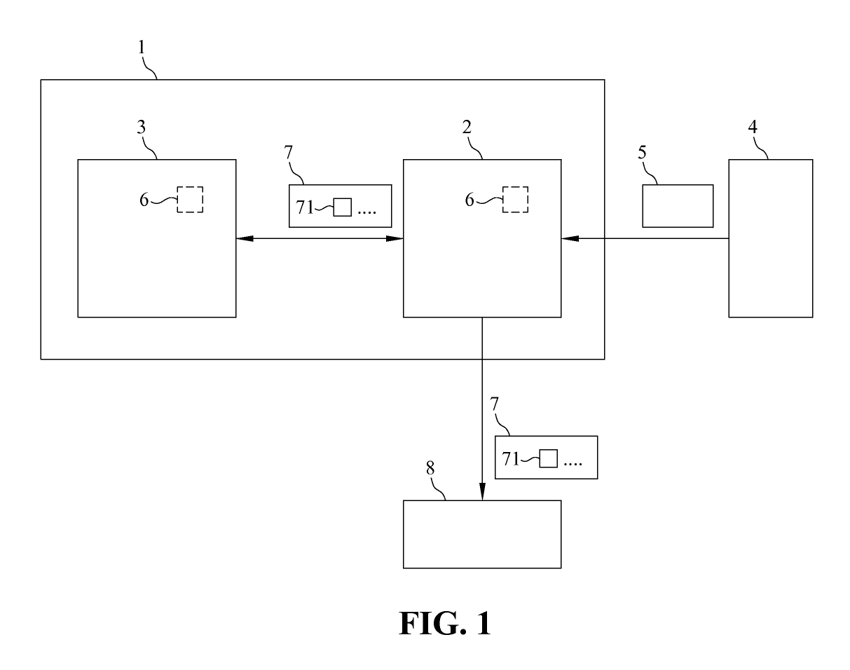

FIG. 1 is a schematic diagram illustrating a structure of a vehicle diagnostic system and the operation thereof according to an embodiment of the present invention. Referring to FIG. 1, there is shown a vehicle diagnostic system 1 including a receiving/processing module 2, and a database 3.

The vehicle diagnostic system 1 is installed in a notebook computer, and/or a personal computer, and/or a server. The receiving/processing module 2 for example is a software and/or a hardware, and/or a firmware. The receiving/processing module 2 and the database 3 are disposed in a notebook computer, and/or a personal computer, and/or a server. For example, the receiving/processing module 2 and the database 3 are both positioned in a notebook computer, or the receiving/processing module 2 and the database 3 are both positioned in a personal computer, or the receiving/processing module 2 and the database 3 are both positioned in a server. Alternatively, according to an aspect of the embodiment, the receiving/processing module 2 is positioned in a personal computer, while the database 3 is positioned in a server. According to a further aspect of the embodiment, the receiving/processing module 2 is positioned in a notebook computer, while the database 3 is positioned in a server.

The receiving/processing module 2 is adapted for receiving an information 5 related to a status of vehicle components from an OBD-II interface 4 connected thereto. For example, the information includes diagnostic trouble codes (DTC), designated data, additional information, and parameters related to the status of the vehicle components. The received information 5 is then analyzed and processed by a processing logic 6, so as to obtain a vehicle health diagnostic report 7 related to the vehicle components being diagnosed. The vehicle health diagnostic report 7 includes one or more table(s) 71. The table(s) 71 is/are stored in the database 3. In the vehicle health diagnostic report 7 including the table(s) 71, in addition to enumerating the operation status of the vehicle components as “Pass/Fail”, there is also showed a testing result of the vehicle components, and there are also provided additional information and suggestions related to the vehicle components. The processing logic 6 is stored in receiving/processing module 2 and/or in the database 3.

The database 3 is adapted for storing the vehicle health diagnostic report 7 including the table(s) 71, and/or the processing logic 6. The receiving/processing module 2 accesses the database 3 for retrieving the processing logic 6 therefrom and for preparing the vehicle health diagnostic report 7 related to the vehicle components. Further, according to an aspect of the invention, the receiving/processing module 2 accesses the database 3 for retrieving the vehicle health diagnostic report 7 including the table(s) 71 stored in the database 3, and provides the vehicle health diagnostic report 7 to an additional system 8 for printing the vehicle health diagnostic report 7 into a paperwork or displaying the vehicle health diagnostic report 7 on a display screen (not shown in the drawings), so as to allow the user to be aware of the additional information and suggestions related to the vehicle components.

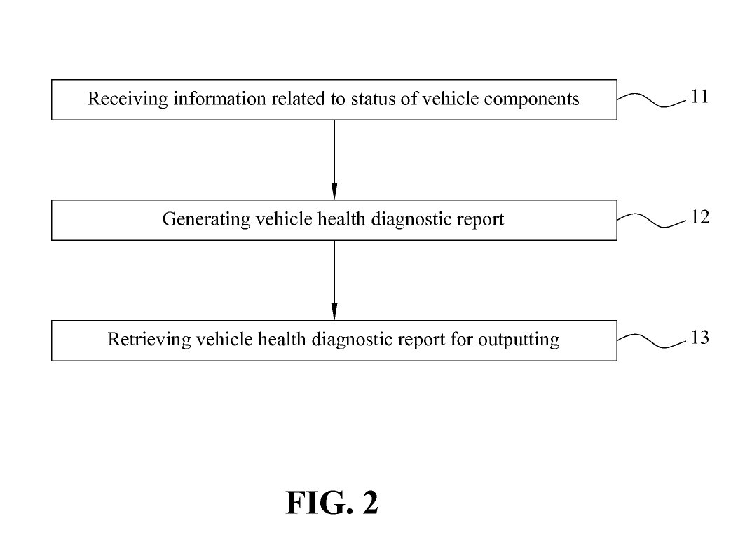

FIG. 2 is a flow chart illustrating steps of a vehicle diagnostic method executed with the vehicle diagnostic system of FIG. 1 according to an embodiment of the present invention. Referring to FIG. 2, at step 11, the receiving/processing module is utilized to receive an information 5 related to a status of vehicle components from an OBD-II interface 4 connected thereto. For example, the information includes diagnostic trouble codes (DTC), designated data, additional information, and parameters related to the status of the vehicle components. Then, the flow goes to step 12.

At step 12, the received information 5 is then analyzed and processed by a processing logic 6, so as to obtain a vehicle health diagnostic report 7 related to the vehicle components being diagnosed. The vehicle health diagnostic report 7 includes the table(s) 71. The table(s) 71 is/are stored in the database 3. Then, the flow goes to step 13.

At step 13, the receiving/processing module 2 accesses the database 3 for retrieving the vehicle health diagnostic report 7 including the table(s) 71 stored in the database 3, and provides the vehicle health diagnostic report 7 to an additional system 8.

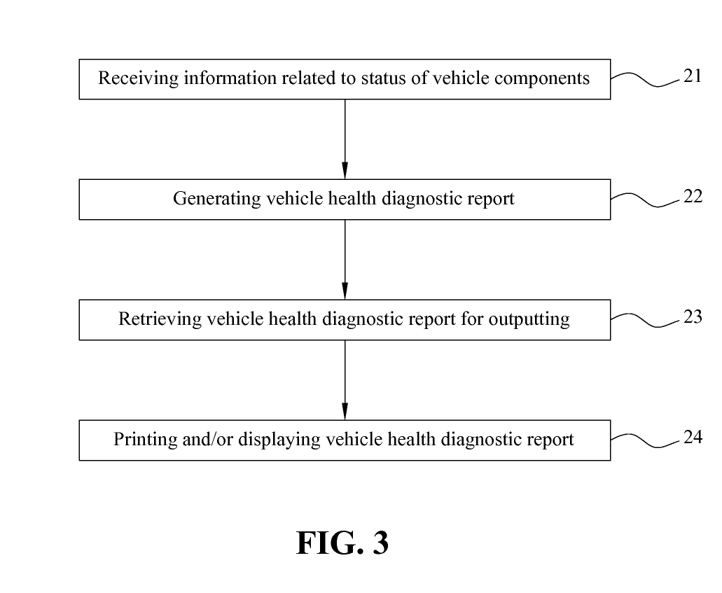

FIG. 3 is a flow chart illustrating steps of a vehicle diagnostic method executed with the vehicle diagnostic system of FIG. 1 according to a further embodiment of the present invention. Referring to FIG. 3, at step 21, the receiving/processing module is utilized to receive an information 5 related to a status of vehicle components from an OBD-II interface 4 connected thereto. For example, the information includes diagnostic trouble codes (DTC), designated data, additional information, and parameters related to the status of the vehicle components. Then, the flow goes to step 22.

At step 22, the received information 5 is then analyzed and processed by a processing logic 6, so as to obtain a vehicle health diagnostic report 7 related to the vehicle components being diagnosed. The vehicle health diagnostic report 7 includes one or more table(s) 71. The table(s) 71 is/are stored in the database 3. Then, the flow goes to step 23.

At step 23, the receiving/processing module 2 accesses the database 3 for retrieving the vehicle health diagnostic report 7 including the table(s) 71 stored in the database 3, and provides the vehicle health diagnostic report 7 to an additional system 8. The, the flow goes to step 24.

At step 24, the additional system 8 prints the vehicle health diagnostic report 7 into a paperwork or displays the vehicle health diagnostic report 7 on a display screen, so as to allow the user to be aware of the additional information and suggestions related to the vehicle components.

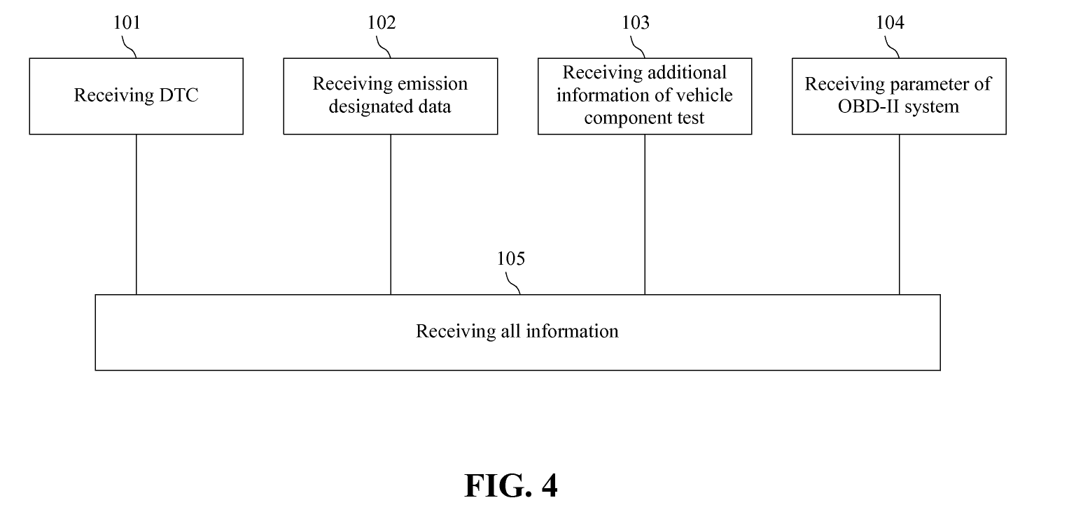

FIG. 4 is a flow chart illustrating a detailed procedure of the step of receiving the information related to a status of the vehicle components of FIGS. 2 and 3. Referring to FIG. 4, at step 101, the receiving/processing module 2 receives the DTC, and then the flow goes to step 105. At step 102, the receiving/processing module 2 receives a designated data of an evaporative emission system and/or a fuel injection system, and then the flow goes to step 105. At step 103, the receiving/processing module 2 receives additional information of the component test, and then the flow goes to step 105. At step 104, the receiving/processing module 2 receives parameters of the OBD-II system, and then the flow goes to step 105.

At step 105, the receiving/processing module 2 receives all information related to the status of the vehicle components.

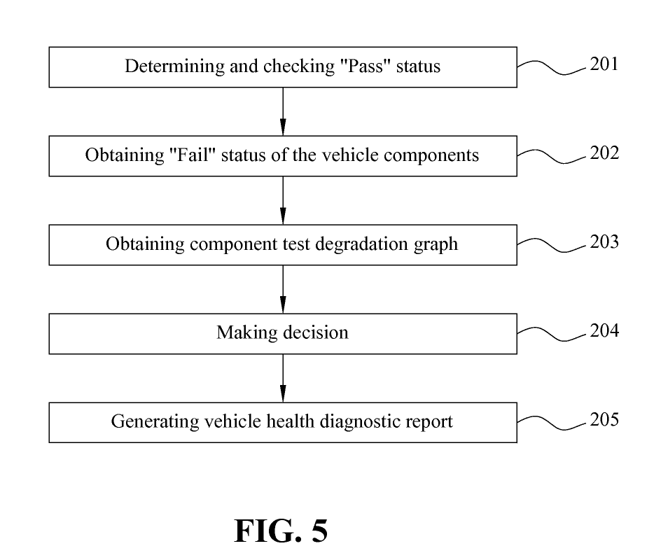

FIG. 5 is a flow chart illustrating a detailed procedure of the step of generating a vehicle health diagnostic report of FIGS. 2 and 3. As shown in FIG. 5, at step 201, the receiving/processing module 2 receives the information 5, e.g., the DTC, the designated data, the additional information, and the parameters, and the processing logic 6 analyzes and processes the received information 5, so as to determine a “Pass” status of the vehicle components. Then, the flow goes to step 202.

At step 202, in accordance with the analysis conducted by the processing logic 6, the receiving/processing module 2 determines a “Fail” status of the vehicle components from more than one summary table (not shown in the drawings). The more than one summary tables show a testing result of a plurality of sensors, and/or a testing the vehicle component test, and/or a testing result of the DTC test, and/or a result of an emission test of an evaporative emission system and/or a fuel injection system. The testing result of the sensors for example shows a quantity of sensors determined as “Good”, and/or “Normal”, and/or “Warning”, and/or “Disabled”. The testing result of the vehicle components for example shows a quantity of vehicle components determined as “Pass” or “Fail”. The testing result of the DTC test for example shows the bright/dark status of the engine light related to the DTC, and whether the DTC is plural. The result of the emission test for example shows the quantity of the monitor items. Then, the flow goes to step 203.

At step 203, in accordance with the analysis conducted by the processing logic 6, and according to the measurement, upper specification, lower specification of the vehicle components, the receiving/processing module 2 calculates to obtain a component test degradation graph (not shown in the drawings). Then, the flow goes to step 204.

At step 204, according to the component test degradation graph, the receiving/processing module 2 determines whether the testing result of the sensors, and/or vehicle components, and/or DTCs, and/or emission test are “Pass” or “Fail”, and then the flow goes to step 205.

At step 205, the receiving/processing module 2 generates a vehicle health diagnostic report 7 related to the vehicle components being diagnosed. The vehicle health diagnostic report 7 includes one or more table 71, and the table(s) 71 is/are stored in the database 3.

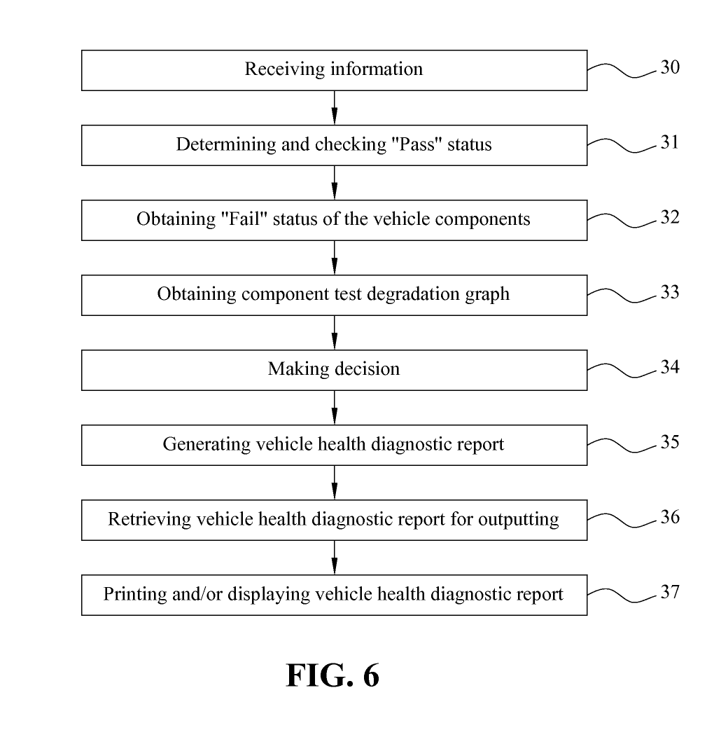

FIG. 6 is a flow chart illustrating the procedure of executing the vehicle diagnostic method of FIG. 3 according to an embodiment of the present invention. Referring to FIG. 6, firstly, at step 30, the receiving/processing module 2 receives the DTC, the designated data of the evaporative emission system and/or a fuel injection system, the additional information of the component test, the parameters of the OBD-II system. In other words, at step 30, the receiving/processing module 2 receives all information 5 related to the status of the vehicle components, and then the flow goes to step 31.

At step 31, facilitated by the processing logic, the receiving/processing module 2 determines and checks the “Pass” status of the vehicle components, and then the flow goes to step 32.

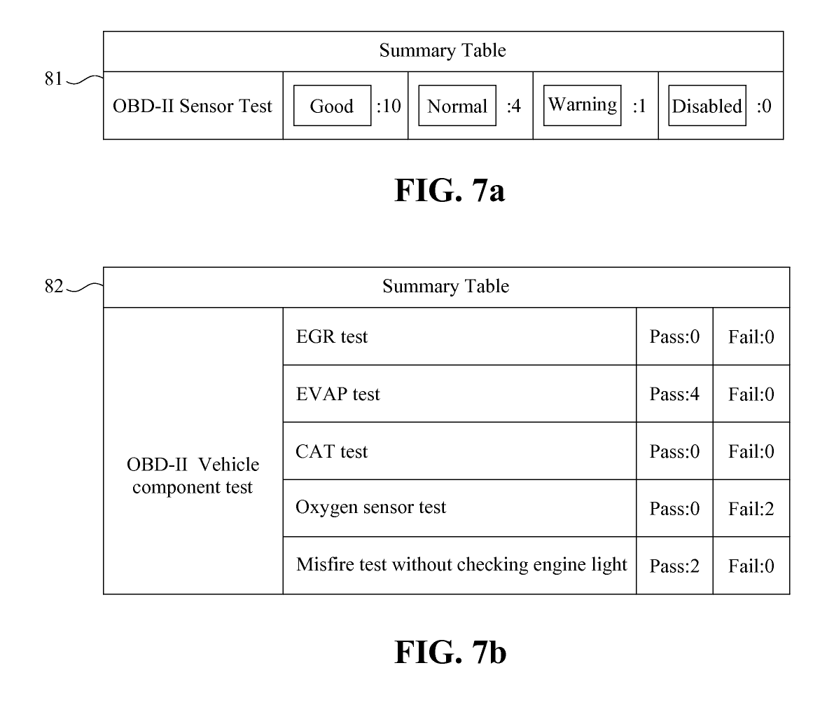

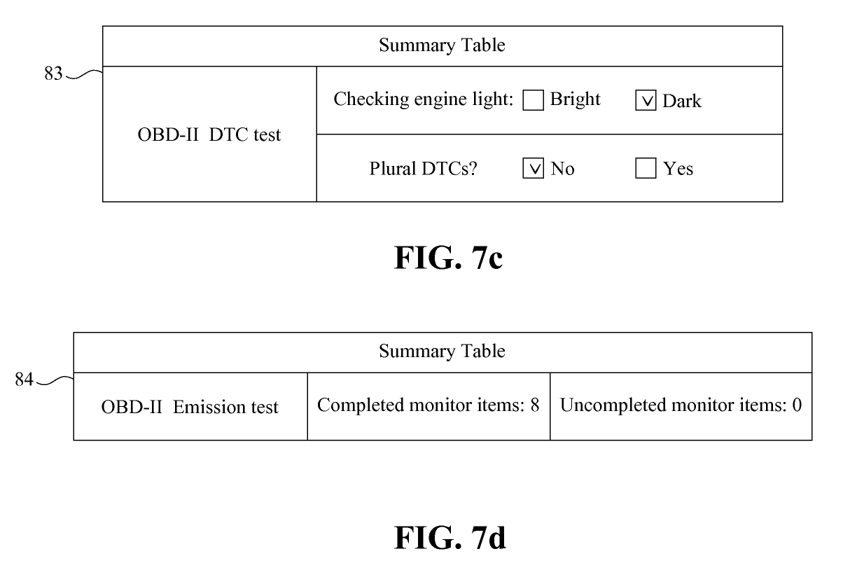

At step 32, in accordance with the analysis conducted by the processing logic 6, the receiving/processing module 2 determines a fail status of the vehicle components from one or more table 81, 82, 83, and 84. FIG. 7a is a summary table 81 showing the testing result of a plurality of sensors. FIG. 7b is a summary table 82 showing a testing result of the vehicle component test. FIG. 7c is a summary table 83 showing a testing result of the DTC test. FIG. 7d is a summary table 84 showing a testing result of the emission test of an evaporative emission system and/or a fuel injection system. As shown in FIG. 7a, the testing result of the sensors shows 10 “Good”, 4 “Normal”, 0 “Warning”, and 1 “Fail”. As shown in FIG. 7b, the testing result of the vehicle component test includes 0 “Pass” and 0 “Fail” of the exhaust gas recirculation (EGR) system test, 4 “Pass” and 0 “Fail” of the evaporative emission system (EVAP) test, 0 “Pass” and 0 “Fail” of the oxygen sensor system test, and 2 “Pass” and 0 “Fail” of the engine misfire test without checking engine light. As shown in FIG. 7c, the testing result of the DTC test the engine lamp, which is related to the DTC, is turned dark. As shown in FIG. 7d, the testing result of the emission test shows that there are 8 monitor items tested, and there is no monitor item not tested. Then, the flow goes to step 33.

At step 33, in accordance with the analysis conducted by the processing logic 6, and according to the measurement, upper specification, lower specification of the vehicle components, the receiving/processing module 2 calculates to obtain a component test degradation graph (not shown in the drawings). Then, the flow goes to step 34.

At step 34, according to the component test degradation graph, the receiving/processing module 2 determines whether the testing result of the sensors, and/or vehicle components, and/or DTCs, and/or emission test are “Pass” or “Fail”, and then the flow goes to step 35.

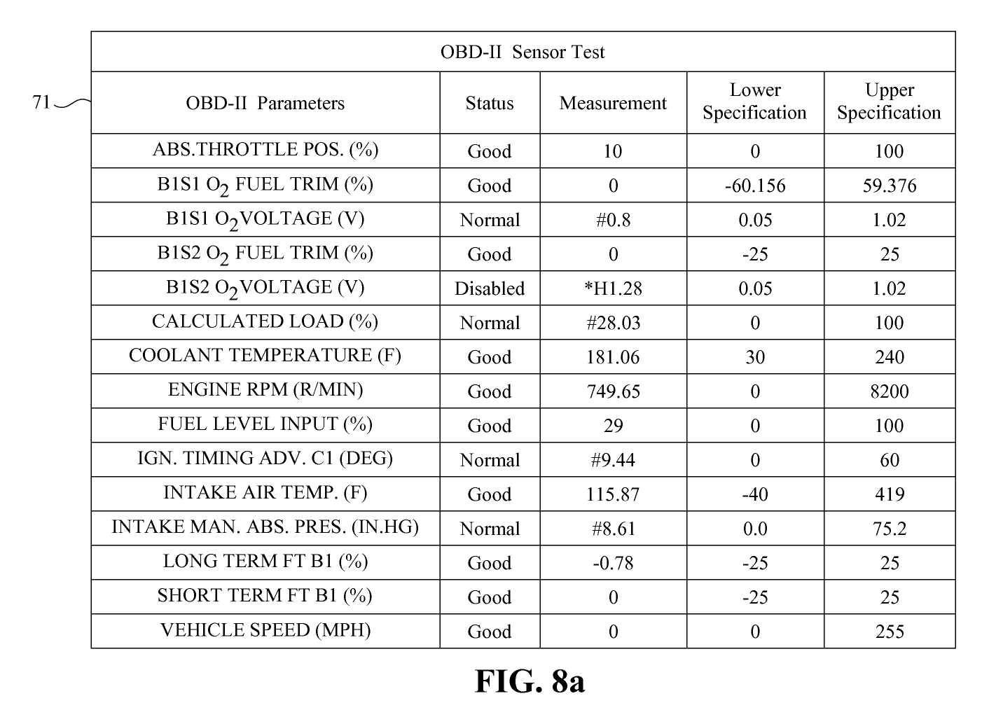

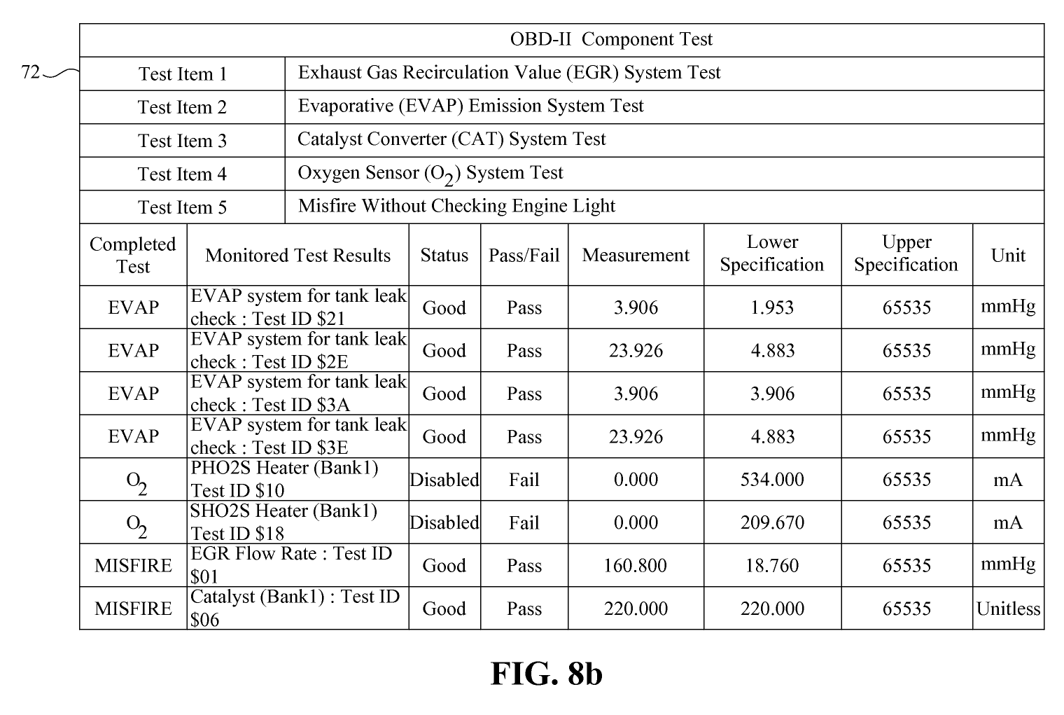

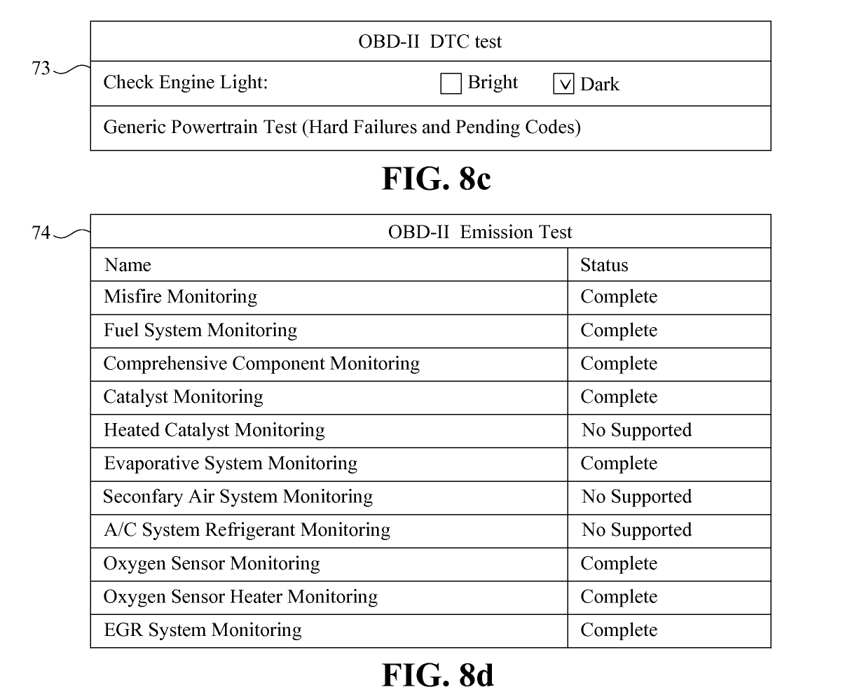

At step 35, the receiving/processing module 2 generates a vehicle health diagnostic report 7 related to the vehicle components being diagnosed. The vehicle health diagnostic report 7 includes one or more table(s) 71, and the table(s) 71 is/are stored in the database 3. Specifically, the vehicle health diagnostic report 7 includes one or more tables, e.g., 71, 72, 73, 74. The tables 71, 72, 73, 74 are respectively shown in FIGS. 8a through 8d. FIG. 8a illustrates the table 71, which shows a testing result of a plurality of sensors of the OBD-II system. FIG. 8b illustrates the table 72 which shows a result of a component test of the OBD-II system. FIG. 8c illustrates the table 73 which shows a result of a DTC test of the OBD-II system. FIG. 8d illustrates the table 74 which shows a result of an emission test of the OBD-II system. Then the flow goes to step 36.

At step 36, the receiving/processing module 2 accesses the database 3 for retrieving the vehicle health diagnostic report 7 including the tables 71, 72, 73, and 74 stored in the database 3, and provides the vehicle health diagnostic report 7 to the additional system 8. The, the flow goes to step 37.

At step 37, the additional system 8 prints the vehicle health diagnostic report 7 into a paperwork or displays the vehicle health diagnostic report 7 on a display screen, so as to allow the user to be aware of the additional information and suggestions related to the vehicle components.

FIG. 7a is a summary table 81 showing the testing result of a plurality of sensors. As shown in FIG. 7a, the testing result of the sensors shows 10 “Good”, 4 “Normal”, 0 “Warning”, and 1 “Fail”.

FIG. 7b is a summary table 82 showing a testing result of the vehicle component test. As shown in FIG. 7b, the testing result of the vehicle component test includes 0 “Pass” and 0 “Fail” of the exhaust gas recirculation (EGR) system test, 4 “Pass” and 0 “Fail” of the evaporative emission system test, 0 “Pass” and 0 “Fail” of the oxygen sensor system test, and 2 “Pass” and 0 “Fail” of the engine misfire test.

FIG. 7c is a summary table 83 showing a testing result of the DTC test. As shown in FIG. 7c, the testing result of the DTC test the engine lamp, which is related to the DTC, is turned dark.

FIG. 7d is a summary table 84 showing a testing result of the emission test of an evaporative emission system and/or a fuel injection system. As shown in FIG. 7d, the testing result of the emission test shows that there are 8 monitor items tested, and there is no monitor item not tested.

FIG. 8a illustrates the table 71, which shows a testing result of a plurality of sensors of the OBD-II system. FIG. 8b illustrates the table 72 which shows a result of a component test of the OBD-II system. FIG. 8c illustrates the table 73 which shows a result of a DTC test of the OBD-II system. FIG. 8d illustrates the table 74 which shows a result of an emission test of the OBD-II system.

As shown in FIGS. 8a through 8d, the vehicle health diagnostic report 7 including a plurality of tables 71, 72, 73, 74, does not only show the testing result of the vehicle component test, but also provides additional information and suggestions related to the vehicle components, e.g., the status of the components are “Good”, “Normal”, “Warning”, or “Disabled”.

According to the foregoing embodiments, a vehicle diagnostic system and a method thereof are obtained. The vehicle diagnostic system and the method thereof are adapted for accessing to retrieve DTCs, designated data, additional information, parameters related to the status of the vehicle components being diagnosed from the OBD-II interface. The retrieved information is then processed by a processing logic, and then obtaining a vehicle health diagnostic report related to the vehicle components. In the vehicle health diagnostic report, in addition to displaying a status of health information for the vehicle sub-systems as either “Pass” or “Fail”, additional information and suggestions related to the vehicle components are also provided.

The vehicle diagnostic system has the following advantages:

1. In the vehicle health diagnostic report, in addition to displaying a status of health information for the vehicle sub-systems as either “Pass” or “Fail”, additional information and suggestions related to the vehicle components are also provided; and

2. The present invention provides a vehicle diagnostic system and a method thereof. The vehicle diagnostic system and the method thereof are adapted for accessing to retrieve DTCs, designated data, additional information, parameters related to the status of the vehicle components being diagnosed from the OBD-II interface. The retrieved information is then processed by a processing logic, and then obtaining a vehicle health diagnostic report related to the vehicle components.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A vehicle diagnostic method, adapted for diagnosing a vehicle, comprising:
receiving an information related to a status of vehicle components comprising diagnostic trouble codes (DTC), designated data, additional information, and parameters of an OBD-II system from an OBD-II system interface;
generating a vehicle health diagnostic report related to the vehicle components, wherein the vehicle health diagnostic report comprises one or more table; and
outputting the vehicle health diagnostic report to an additional system, wherein the one or more table show a testing result of the vehicle components, and provide additional information and suggestions related to the vehicle components.

2. The vehicle diagnostic method according to claim 1, further comprising:
the additional system printing the vehicle health diagnostic report into paperwork or displaying the vehicle health diagnostic report on a display screen, for allowing a user to be aware of the additional information and suggestions related to the vehicle components.

3. The vehicle diagnostic method according to claim 1 or 2, wherein the step of receiving the information related to the status of the vehicle components comprises:
receiving the DTCs;
receiving the designated data which is an emission designated data;
receiving the additional information of a vehicle component test; and
receiving the parameters of the OBD-II system.

4. The vehicle diagnostic method according to claim 1 or 2, wherein the step of generating a vehicle health diagnostic report related to the vehicle components comprises:
after receiving the DTCs, the designated data, the additional information, the parameter, determining respective status of each of the vehicle components as “Pass” or “Fail”;
obtaining a “Fail” status of the vehicle components from more than one summary table;
calculating to obtain a component test degradation graph, according to a measurement, an upper specification, a lower specification of the vehicle components;
making a determination according to the component test degradation graph; and
generating a vehicle health diagnostic report related to the vehicle components.

5. The vehicle diagnostic method according to claim 1 or 2, wherein the additional information and suggestions related to the vehicle components comprise a status of the vehicle components.

6. The vehicle diagnostic method according to claim 3, wherein the emission designated data is a designated data of an evaporative emission system and/or a fuel injection system.

7. The vehicle diagnostic method according to claim 4, wherein the more than one summary tables show a testing result of a plurality of sensors, and/or a testing the vehicle component test, and/or a testing result of the DTC test, and/or a result of an emission test of an evaporative emission system and/or a fuel injection system.

8. The vehicle diagnostic method according to claim 4, wherein the made decision is whether the respective testing result of the sensors, and/or the vehicle components, and/or the DTC test, and/or the emission test is “Pass” or “Fail”.

9. The vehicle diagnostic method according to claim 5, wherein the status is one of “Good”, “Normal”, “Warning”, and “Disabled”.

10. The vehicle diagnostic method according to claim 7, wherein the testing result of the sensors shows a quantity of sensors determined as “Good”, and/or “Normal”, and/or “Warning”, and/or “Disabled”; the testing result of the vehicle components shows a quantity of the vehicle components which are determined as “Pass” or “Fail”; the testing result of the DTC test shows a bright/dark status of an engine light related to the DTC, and whether the DTC is plural; and the result of the emission test shows a quantity of monitor items which are completed.

11. A vehicle diagnostic method, adapted for diagnosing a vehicle, comprising:
receiving diagnostic trouble codes (DTC), emission designated data, additional information of a vehicle component test, and parameters of an OBD-II system;
determining and checking a “Pass” status of vehicle components of the vehicle;
obtaining a “Fail” status of the vehicle components from one or more summary tables;
calculating to obtain a component test degradation graph, according to a measurement, an upper specification, a lower specification of the vehicle components;
making a decision according to the component test degradation graph;
generating a vehicle health diagnostic report comprising one or more table related to the vehicle components;
outputting the vehicle health diagnostic report to an additional system; and
the additional system printing the vehicle health diagnostic report into a paperwork or displaying the vehicle health diagnostic report on a display screen, for allowing a user to be aware of the additional information and suggestions related to the vehicle components,
wherein the one or more table show a testing result of the vehicle component, and providing additional information and suggestions related to the vehicle components.

12. The vehicle diagnostic method according to claim 11, wherein the additional information and suggestions related to the vehicle components comprise a status of the vehicle components.

13. The vehicle diagnostic method according to claim 11, wherein the emission designated data is a designated data of an evaporative emission system and/or a fuel injection system.

14. The vehicle diagnostic method according to claim 11, wherein the more than one summary tables show a testing result of a plurality of sensors, and/or a testing the vehicle component test, and/or a testing result of the DTC test, and/or a result of an emission test of an evaporative emission system and/or a fuel injection system.

15. The vehicle diagnostic method according to claim 11, wherein the made decision is whether the respective testing result of the sensors, and/or the vehicle components, and/or the DTC test, and/or the emission test is “Pass” or “Fail”.

16. The vehicle diagnostic method according to claim 12, wherein the status is one of “Good”, “Normal”, “Warning”, and “Disabled”.

17. The vehicle diagnostic method according to claim 14, wherein the testing result of the sensors shows a quantity of sensors determined as “Good”, and/or “Normal”, and/or “Warning”, and/or “Disabled”; the testing result of the vehicle components shows a quantity of the vehicle components which are determined as “Pass” or “Fail”; the testing result of the DTC test shows a bright/dark status of an engine light related to the DTC, and whether the DTC is plural; and the result of the emission test shows a quantity of monitor items which are completed.

18. A vehicle diagnostic system, adapted for diagnosing a vehicle, comprising:
a database; and
a receiving/processing module, wherein the receiving/processing module is adapted for:
receiving an information related to a status of vehicle components of the vehicle, wherein the information comprises diagnostic trouble codes (DTC), designated data, additional information, and parameters from an OBD-II system interface;
generating a vehicle health diagnostic report related to the vehicle components, while facilitated with a processing logic for processing the received information, wherein the vehicle health diagnostic report comprises one or more table, and the one or more table are stored in the database; and
accessing and retrieving the vehicle health diagnostic report comprising the one or more table from the database, and outputting the retrieved vehicle health diagnostic report to an additional system;
wherein the processing logic is stored in the database and/or the receiving/processing module, and the one or more table show a testing result of the vehicle components, and provide additional information and suggestions related to the vehicle components.

19. The vehicle diagnostic system according to claim 18, wherein the diagnostic trouble codes (DTC), the designated data, the additional information, and the parameters are DTCs, emission designated data, additional information of a vehicle component test, and parameters of an OBD-II system, respectively.

20. The vehicle diagnostic system according to claim 18, wherein the vehicle health diagnostic report is generated by executing a procedure comprising the following steps:
the receiving/processing module, in accordance with an analysis performed by the processing logic, obtaining a “Fail” status of the vehicle components from more than one summary table;
the receiving/processing module, in accordance with an analysis performed by the processing logic, calculating to obtain a component test degradation graph, according to a measurement, an upper specification, a lower specification of the vehicle components;
the receiving/processing module, in accordance with an analysis performed by the processing logic, making a determination according to the component test degradation graph; and
the receiving/processing module, in accordance with an analysis performed by the processing logic, generating the vehicle health diagnostic report related to the vehicle components.

21. The vehicle diagnostic system according to claim 18, wherein the additional information and suggestions related to the vehicle components comprise a status of the vehicle components.

22. The vehicle diagnostic system according to claim 19, wherein the emission designated data is a designated data of an evaporative emission system and/or a fuel injection system.

23. The vehicle diagnostic system according to claim 20, wherein the more than one summary tables show a testing result of a plurality of sensors, and/or a testing the vehicle component test, and/or a testing result of the DTC test, and/or a result of an emission test of an evaporative emission system and/or a fuel injection system.

24. The vehicle diagnostic method according to claim 20, wherein the made decision is whether the respective testing result of the sensors, and/or the vehicle components, and/or the DTC test, and/or the emission test is “Pass” or “Fail”.

25. The vehicle diagnostic method according to claim 21, wherein the status is one of “Good”, “Normal”, “Warning”, and “Disabled”.

26. The vehicle diagnostic method according to claim 23, wherein the testing result of the sensors shows a quantity of sensors determined as “Good”, and/or “Normal”, and/or “Warning”, and/or “Disabled”; the testing result of the vehicle components shows a quantity of the vehicle components which are determined as “Pass” or “Fail”; the testing result of the DTC test shows a bright/dark status of an engine light related to the DTC, and whether the DTC is plural; and the result of the emission test shows a quantity of monitor items which are completed.
